(19) United States
(12) Patent Application Publication
(10) Pub. No.: US 2006/0127202 A1
(43) Pub. Date: Jun. 15, 2006

(54) Refuse collecting apparatus for a refuse collecting vehicle

(76) Inventor: Thorvaldur Tryggvason, Basse-Goulaine (FR)

Correspondence Address: BIRCH STEWART KOLASCH & BIRCH, PO BOX 747, FALLS CHURCH, VA, 22040-0747, US

(21) Appl. No.: 10/533,418

(22) PCT Filed: Oct. 30, 2003
(86) PCT No.: PCT/IS03/00033

§ 371 Date: Apr. 29, 2005

(30) Foreign Application Priority Data
Oct. 30, 2002 (IS) 6604

(51) Int. Cl. G01G 13/00; G01G 19/08; B65B 21/02; G01G 19/14; G04F 5/00; B65B 1/32

(52) U.S. Cl. 414/21; 700/305; 702/174; 414/407; 53/502; 177/136

(57) ABSTRACT

This invention relates to a refuse collecting apparatus arranged on a refuse collection vehicle for emptying waste bins into a waste container arranged on the refuse collection vehicle. A frame member is arranged on a said refuse collection vehicle, a lifting mechanism with a gripping and support mechanism for said waste bins is secured to the frame member and one characteristic property related to the lifting mechanism is monitored and comparated to information relating to the waste bins which is provided through reading bar code or computer chip prior to lifting and emptying it into said waste container. Such characteristic property being for example the applied current to an electrical motor drive and the information being for example the maximum weight allowed for said waste bin. By arranging the waste bin on the lifting mechanism the mecanism is activated or inactivated as a result thereof.

### FIELD OF THE INVENTION

The present invention relates to a refuse collecting apparatus arranged on a refuse vehicle for emptying waste bins into container arranged on said refuse vehicle.

### BACKGROUND

Refuse vehicles and numerous apparatus for the purpose of refuse collection are well known. A typical refuse vehicle consists of a waste container and a hydraulic driven lifting mechanism with a gripping and emptying mechanism for waste bins arranged on the vehicle chassis. Such lifting mechanism is usually very powerful and normally does not differentiate between light and heavy waste bins in the power applied. One of the problems that follow is that a very heavy waste bin can easily crack as the bin is lifted and such power is applied. This may cause an injury for the operators of such mechanism. Also, some refuse vehicles are provided with compactor for pressing the incoming waste, thereby minimizing the volume of the waste in the refuse vehicle. However, today it happens that unwanted items such as engine parts follows the waste, which can easily cause damages to the compactor.

Today, there is an increasing demand for all waste to be weighed and that the user pays for the waste disposed pr. kg. Therefore, some lifting mechanisms have been equipped with weighing means for weighing the waste.

A number of prior art references describe apparatus and methods teaching the use of weighing means arranged on lifting mechanism of waste collecting vehicles for determining the weight of the waste bin prior to emptying. In WO 93/17308, U.S. Pat. No. 4,645,018 and DE 3,910,791 such apparatus and methods are described.

Due to the fact that the majority of lifting mechanism is hydraulic driven it has however been very difficult to perform an accurate weighing.

Furthermore, the working environment of the operator of such lifting mechanism has been determined quite severe and dangeours, and the safety demands are being strengthened. Accordingly the most recent requirements set forth require that the device does not lift certain types of bins heavier than say 1,25 times maximum allowed load for that particular bin. It is a fact that no lifting mechanism in today's refuse vehicles does fulfil these conditions.

Also, lifting mechanism for refuse vehicles are generally made as multi purpose devices, i.e. they are used for lifting many different types and sizes of bins in the same round. Due to this it is quite difficult to fulfill todays most recent requirments.

There is therefore a need for a refuse collecting apparatus to be arranged on a refuse collection vehicle, with a safety device for preventing that accident occur due to overloaded bins, and which fulfils the requirements and optionally where the weight of the waste may be determined accurately.

### DESCRIPTION OF THE INVENTION

It is an object of the present invention to provide a refuse collecting apparatus, which fulfills the requirement set forth, and which utilizes information obtained from waste bins, such as container code data, to determine at least one information for the waste bins, typically the maximum weight allowed for the waste bins. This has the advantage that the bins may have different maximum weight limits due to different structures. Some may have high weight limit, such as waste bins for industrial use, and some will have lower weight limits, such as the ones used in residential areas.

Another object of the present invention is to provide a mechanism that monitors at least one characteristic property of the lifting mechanism and in response thereto activates or inactivates the liftng mechanism and thereby either accepts or rejects lifting of the waste bins, depending on whether its weight is below or above the upper weight limit.

According to the first aspect, the present invention relates to a refuse collecting apparatus arranged on a refuse collection vehicle for lifting and emptying waste bin into a waste container arranged on said refuse collection vehicle, said apparatus comprising:
a frame member arranged on said refuse collection vehicle,
a lifting and emptying mechanism secured to said frame member comprising a gripping and a supporting mechanism for said waste bin,
a detecting means for obtaining at least one information relating to said waste bin,
a mechanism for monitoring at least one characteristic property related to said lifting mechanism,
a control unit for utilizing said at least one information for determining at least one criteria for lifting said waste bin, whereby arranging said waste bin on said lifting mechanism said at least one characteristic property is determined and compared to said criteria and based thereon the lifting mechanism is activated or not activated.

In one embodiment the mechanism for monitoring at least one characteristic property of said waste bins is a measuring device for measuring change in the load of the lifting mechanism or the power required to lift said waste bins, such as by monitoring the applied current used by the motor drive. said motor drive being an electrical motor allowing for example measuring of the change in load in the form of electrical current used for operating the motor. Another way would be to use a strain-gauge to measure changes in structural strain In the lifting, gripping or supporting mechanism and based thereon calculate changes in force applied. Other types of monitoring means may also be integrated into the lifting mechanism, such as weighing means. One preferred criteria to determine based on the information and the characteristic property is the upper weight limit of the waste bins. This is preferably done by obtaining information relating to the volume/size of the waste bin, which may be provided through an identification tag on the waste bins. Such identification tag may be in the form of bar code, programmable computer chip. Based on the volume information, the maximum weight limit of the bins can easily be estimated by multiplying an average mass density with said volume.

Accordingly, as the measured load of the lifting mechanism for the waste bins exceeds said upper limit, lifting of the bin is rejected by non-activation of the mechanism. By providing the collecting apparatus with an alerting system, wherein as the weight of the waste bin exceeds said upper weight limit either in the initial phase before lifting or during the lifting phase, the alerting system is activated or simply by rejecting it by the operator, which compares the actual weight to the upper weight limit. Thereby, the risk of the waste bin cracking is prevented and thereby possible accident caused by the fall of the bin.

In another embodiment the refuse collecting apparatus is further provided with a computer system. Thereby, the operator may select an upper weight limit, which is stored in the computer system and wherein the apparatus determines automatically weather the weight exceeds the stored upper weight limit or not. Example: in a normal residential area the bins vary in size and consequently their upper weight limit varies as well. Typically there would be found 3-6 different upper weight limits in the same round. Rounds are almost never homogeneous in terms of bin size. The same applies for industrial refuse collection, which typically vary in size—between 120 I to 1.100 I bins in the same round.

The lifting mechanism may in one embodiment comprise a conveyor belt arranged between two wheels (such as driving wheel and a sprocket wheel) such that the belt forms an endless loop, and is fastened vertically on said frame member. In a first position, the waste bin is hooked on the gripping and the support mechanism. The characteristic property being for example the current used by the motor drive for the lifting mechanism and compared to said criteria being such as the upper weight limit. In order to control the lifting mechanism accurately, it is preferred that the lifting mechanism is electrically driven.

In still another embodiment the lifting mechanism is exchangeable, i.e. different lifting mechanism may be secured to the same frame member. It follows that the same refuse collection vehicle can be provided with different lifting mechanism and thereby the same refuse collection vehicle may be used in an industrial area or in a normal residential area, where the upper weight limits are different.

In a further embodiment two or more lifting mechanisms are arranged side by side on said frame member and wherein the lifting mechanisms are displaceable such that they may act as independent units or together as a single unit.

### DETAILED DESCRIPTION

In the following the present invention and more particularly the preferred embodiment thereof is described in more details, in which

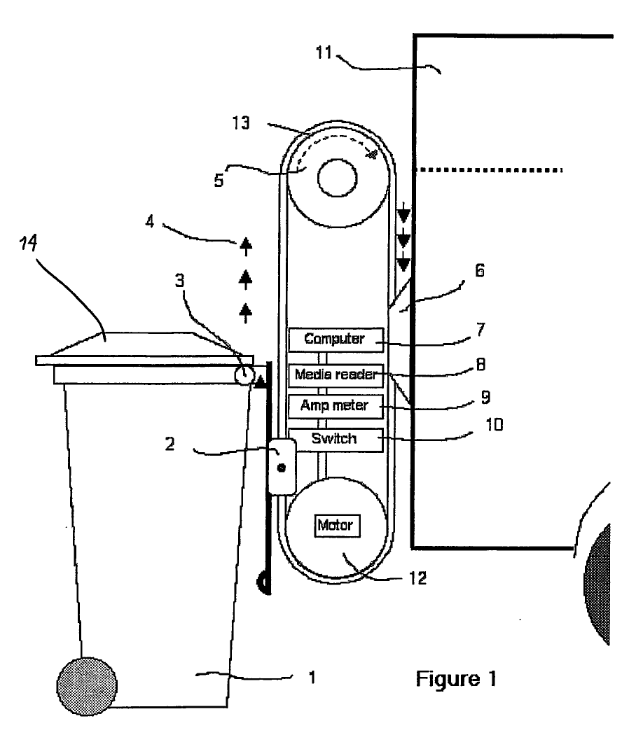

FIG. 1 shows a collecting apparatus arranged on a refuse collection vehicle 11, a waste bin 1 and the lifting mechanism 13. As FIG. 1 shows the lifting apparatus arranged vertical on the frame member 6. In one embodiment the frame member is such that the lifting mechanism is displaceable horizontal and optionally vertical. Thereby, one or more lifting mechanism 12 may be arranged on the frame member and run simultaneously. In another embodiment said one or more lifting mechanisms may run as one unit in lifting as an example the same waste bin. Also, the fastening between the lifting mechanism and the frame member is such that the lifting mechanism is changeable. Therefore, a refuse collection vehicle is not bound to the same lifting mechanism.

In FIG. 1 the waste bin 1 is labelled with at least one information, such as the volume and/or the type of the bin through a media such as RFID chip or a Bar-Code and these are extracted with a media reader 8 which transmits information to a computer 7, which utilizes the information to determine at least one information relating to the bin. An operator may be provided with such media reader, or the media reader may be arranged on the lifting mechanism.

In one preferred embodiment, said information is the upper weight limit, whereby the upper weight limit is determined by multiplying the volume with an average mass density. The weighing limit may also be predetermined for different bin volumes, e.g. 150-litre bin corresponds to 70 kg etc. This information may be obtained as an example by scanning the media 3 on the waste bin.

After arranging the bin 1 on the lifting and emptying mechanism 2, a characteristic property related to lifting of the bin is monitored. Reading the current required by the electrical motor (12) to lift the waste bin, on an Amper meter 9 through said computer 7 wherein these values are used to read the weight of the bin. If the weight exceeds an upper weight limit, the computer 7 turns off a switch 10 and the lifting is interrupted. The operator may also stop the lifting manually. The collecting apparatus may be provided with alerting system, which would be integrated into the lifting mechanism, and wherein said alerting system would be activated when the weight of said waste bin exceeds said upper weight limit.

In the most preferred embodiment, the lifting mechanism 13 is electrically driven, which has the advantage that the lifting may be very well controlled and the weighing is exact. As shown the lifting mechanism comprises a conveyor belt arranged between two wheels, a motor driving wheel 12 and a sprocket wheel 5, wherein the belt forms an endless loop, and is fastened vertically on one side of the garbage container.

As shown in FIG. 1 in a first position, the mechanism is in a vertical position and parallel to the conveyor belt. In this position the waste bin is hooked on the lifting and emptying mechanism. Subsequently, if the waste bin is accepted, it is lifted vertically upwards by the lifting mechanism in the moving direction indicated by the arrows 4 until the moving direction is changed and the waste bin obtains a necessary incline so that the garbage slides into the container (not shown). In this second position the driving of the belt is stopped until the bin is empty. The moving direction is reversed and the bin is moved the same way back to the first position.

Another preferred embodiment is wherein the waste bin (1) is arranged on the lifting and emptying mechanism (13), secured to a gripping and supporting mechanism (2) and then moved with said gripping means upwardly alongside said lifting mechanism. As the opening of the waste bin reaches the upper area (14) of the lifting mechanism, the mechanism and the waste bin is rotated about its upper end and arranged in such a tilted position that the waste will slide from the bin to the alongside arranged container (11). Thereafter the moving cycle is reversed and the bin is moved to its initial position.

1. A refusal collecting apparatus arranged on a refuse collection vehicle (11) for lifting and emptying a waste bin (1) into a waste container arranged on said refuse collection vehicle, said apparatus comprising:
a frame member (6) arranged on said refuse collecting vehicle,
a lifting and emptying mechanism (12,13) secured to said frame member comprising a gripping and supporting mechanism (2) for said waste bins,
a mechanism for monitoring at least one characteristic property related to said lifting mechanism,
the apparatus being characterized by having
a detecting means (8) for obtaining at least one information (3) relating to said waste bin, and
a control unit (7) for utilizing said at least one information for determining at least one criteria for lifting said waste bin, whereby arranging said waste bin on said lifting mechanism said at least one characteristic property is determined and compared to said criteria and based thereon the lifting mechanism is activated or not activated.

2. A refuse collection apparatus according to claim 1, wherein said lifting mechanism is electrically motor driven.

3. A refuse collection apparatus according to claim 1 or 2, wherein said mechanism for determining said at least one characteristic property is a measuring device for measuring change in the load of said lifting mechanism.

4. A refuse collection apparatus according to claim 1 or 2, wherein said measuring of change in loading being either measurement of applied force to said electrical motor or said gripping and supporting mechanism.

5. A refuse collection apparatus according to claim 1 or 2, wherein said characteristic property monitored being the applied current to said electrical motor.

6. A refuse collection apparatus according to claim 1, comprising further mechanism for monitoring a second characteristic property, is a weighing means.

7. A refuse collection apparatus according to claim 1 wherein said criteria being an upper weight limit allowed for said waste bin.

8. A refuse collection apparatus according to claim 1 wherein said detecting means comprise an information reading device such as computer chip reader, bar-code reader or similar for reading information associated to said waste bin.

9. A refuse collection apparatus according to claim 1 wherein said information being in the form of bar code, computer chip or similar arranged on said on said waste bin.

10. A refuse collection apparatus according to claim 1 wherein said bar cod, computer chip or similar comprise such information as the upper weighing limit.

11. A refuse collection apparatus according to claim 1, further comprising an alerting system integrated into said lifting mechanism, and wherein said alerting system is activated whenever the weight of said waste bin exceeds said upper weight limits.

12. A refuse collection apparatus according to claim 1, further comprising a computer system.
